(19) United States
(12) Patent Application Publication
(10) Pub. No.: US 2026/0236522 A1
(43) Pub. Date: Aug. 13, 2026

(54) Multi-Modal Embedding Generation Engine

(71) Applicant: Google LLC, Mountain View, CA (US)

(72) Inventors: Xi Cheng, Kirkland, WA (US); Haiyang Qi, Kirkland, WA (US); Jiashang Liu, Kirkland, WA (US); Wen Zhang, Bellevue, WA (US); Seyed Omid Fatemieh, Bellevue, WA (US)

(21) Appl. No.: 19/052,719

(22) Filed: Feb. 13, 2025

(51) Int. Cl. G06F 16/432; G06F 16/242

(52) U.S. Cl. CPC G06F 16/432; G06F 16/2438

(57) ABSTRACT

Aspects of the disclosed technology include functionality that supports generation of embeddings for a variety of data types, such as for example, text, audio, image, video and structured data. The disclosed technology may take the form of a process or generation engine that generates embedding for multimodal data that are used to populate a serverless cloud data warehouse housing large datasets or to train ML models (e.g., train ML tasks such as classification, regression, clustering, etc.). This supports a variety of application tasks such cross-modality retrieval (e.g., text-to-image search), entity resolution and deduplication, and user recommendations, as well as other tasks.

### BACKGROUND

Data embedding plays an important role in various applications. Embeddings represent real-world objects, such as for example entities, text, images, or videos, numerically (e.g., as an array of numbers or vectors) and enable machine learning models to more efficiently process data. Embeddings form the building blocks of many machine learning applications. Examples of such applications include cross-modal similarity searching, semantic searching, recommendation systems, anomaly or outlier detection, named entity extraction, clustering, classifications, as well as others. In real-world environments, users have a variety of data modalities that require embeddings, such as, for example, text, image, video, different types of structured data, etc. Techniques and tools that provide multi-modal embedding generation (e.g., embeddings for a variety of different types of data, including text, image, video and structured data) are likely to prove useful in such environments.

### SUMMARY

Aspects of the disclosed technology include functionality that supports generation of embeddings for a variety of data types, such as for example, text, audio, image, video and structured data. The disclosed technology may take the form of a process or generation engine that generates embedding for multimodal data that are used to populate a serverless cloud data warehouse housing large datasets or to train ML models (e.g., train ML tasks such as classification, regression, clustering, etc.). This supports a variety of application tasks such as cross-modality retrieval (e.g., text/image-to-image/text searches), entity resolution and deduplication, and user recommendations, as well as other tasks.

The disclosed technology may take the form of a process, apparatus, system or a computer program product. For example, an aspect of the disclosed technology is a process for generating embeddings, comprising: receiving multimodal data, the multimodal data including input text and one or more of input image data and input video data; selecting one or more machine learning models; and applying the one or more machine learning models to the multimodal data to generate data embeddings for a semantic space, wherein the data embeddings configure the semantic space to include relationships between the input text and the one or more of input image data and input video data.

In accordance with this aspect of the disclosed technology, the relationships can be represented by vectors associated with the input text data and the one or more of input image data and input video data. Further in accordance with this aspect of the disclosed technology, a proximity metric associated with the vectors can be used to define the relationships between the input text data and the one or more of input image data and input video data. Further still, the process may comprise storing the data embeddings in a serverless cloud data warehouse. In addition, the data embeddings comprise text embeddings and image embeddings having a same dimensionality. Further still, the same dimensionality can comprise having vectors associated with the data embeddings be equal in size to vectors associated with image embeddings.

Further in accordance with this aspect of the disclosed technology, the process may also comprise querying the serverless cloud data warehouse using a text query and receiving as output response image data or response video data. The process may also comprise using a unified SQL syntax to generate the data embeddings. Further, the process can comprise training one or more downstream machine learning models using the data embeddings. Further still, the process can comprise generating a vector index using the data embeddings.

Additionally, in accordance with this aspect of the disclosed technology, the data embeddings may comprise structured data embeddings and the one or more machine learning models include one or more of a Principal Component Analysis (PCA) model, an AutoEncoder, and Matrix Factorization.

As another example, the disclosed technology may take the form of a system comprising: one or more processing devices; a memory containing instructions, the instructions when executed by the one or more processing devices cause the one or more processing devices to: receive multimodal data, the multimodal data including input text and one or more of input image data and input video data; select one or more machine learning models; and apply the one or more machine learning models to the multimodal data to generate data embeddings for a semantic space, wherein the data embeddings configure the semantic space to include relationships between the input text and the one or more of input image data and input video data.

In accordance with this aspect of the disclosed technology, the instructions when executed by the one or more processing devices can cause the one or more processing devices to output the data embeddings to a serverless cloud data warehouse. Further, the instructions when executed by the one or more processing devices can cause the one or more processing devices to query the serverless cloud data warehouse using a text query and receive as output response image data or response video data. Further still in accordance with this aspect of the disclosed technology, the data embeddings may comprise text embeddings and image embeddings having a same dimensionality. Additionally, the same dimensionality comprises having vectors associated with data embeddings be equal in size to vectors associated with image embeddings. Further in accordance with this aspect of the disclosed technology, the one or more machine learning model includes a multimodal machine learning model.

As another example, the disclosed technology may take the form of one or more non-transitory computer program products storing instructions that, when executed by at least one programmable processor, cause the at least one programmable processor to perform operations comprising: receiving multimodal data, the multimodal data including input text and one or more of input image data and input video data; selecting one or more machine learning models; and applying the one or more machine learning models to the multimodal data to generate data embeddings for a semantic space, wherein the data embeddings configure the semantic space to include relationships between the input text and the one or more of input image data and input video data. In accordance with this aspect of the disclosed technology, the data embeddings comprise text embeddings and image embeddings having a same dimensionality and wherein the same dimensionality comprises having vectors associated with the data embeddings be equal in size to vectors associated with image embeddings.

### BRIEF DESCRIPTION OF THE DRAWINGS

FIG. 1 illustrates an example of a joint embedding vector space.

FIG. 2 illustrates the steps of a process flow in accordance with an aspect of the disclosed technology.

FIG. 3 shows outputs of an example use case in accordance with an aspect of the disclosed technology.

FIG. 4 illustrates a high-level functional architecture in accordance with an aspect of the disclosed technology.

FIG. 5 illustrates a high-level processing flow for an embedding generation engine in accordance with an aspect of the disclosed technology.

FIG. 6 illustrates a system environment in accordance with an aspect of the disclosed technology.

### DETAILED DESCRIPTION

Aspects of the disclosed technology include functionality that supports generation of embeddings for a variety of data types, such as for example, text, audio, image, video and structured data. For example, an aspect of the disclosed technology supports multimodal embeddings generation that enables embedding of text and image data in the same semantic space (e.g., vectors of items similar in meaning are closer together) and with the generated embeddings having the same dimensionality (e.g., text and image embeddings have the same dimensionality or mapping to the same semantic space). This enables, for example, embedding and indexing images and running text searches on the images. The disclosed technology make take the form of an embedding generation engine that operates in a serverless cloud data warehouse. The embedding generation engine operates to provide a unified embedding generation function that takes as input multimodal data (e.g., text, image, video, structured data including I.I.D and user-item interaction-related structure data) and one or more ML and/or generative AI models, and outputs multimodal embeddings associated with the input data. The function (e.g., ML.GENERATE_EMBEDDING) may be implemented as a unified SQL syntax. The output or results of applying the unified embedding generation function may comprise rows in a table (by model) that can be stored in a serverless cloud data warehouse or a database.

The unified embedding function generates embeddings for the multimodal data (text, image, video data) in the same semantic space. In effect, the function generates unified data embeddings that configure a single semantic space to include data embeddings associated with text and image/video data—the semantic space comprising a conceptual map representing relationships between the text data and the image/video data. Computations associated with the function are parallelized. In addition, where structured data embeddings are involved, the disclosed technology uses a scalable implementation of various ML models such as, for example, Principal Component Analysis (PCA), AutoEncoder, and Matrix Factorization. Such implementation may handle hundreds of millions of entities.

Further, embeddings generated by the unified embedding function may be used to train ML models, including ML models used for classification, regression, clustering, etc. Real world applications such as cross modality retrieval (e.g., text to image search), entity resolution and deduplication, user recommendations, etc., may use such trained ML models to provide improved results.

With multimodal embeddings, zero-shot classification of images may be performed by converting a table of images and a separate table containing sentence-like labels to embeddings. The images can then be classified images by computing distance between images and each descriptive label's embedding. These embeddings can then be used as input for training other ML models, such as clustering models in a serverless cloud data warehouse to assist in discovering hidden groupings in data. Embeddings are also useful where free text input is available as a feature; for instance, embeddings of user reviews or call transcripts can be used in a churn prediction model, embeddings of images of a house can be used as input features in a price prediction model, etc.; embeddings instead of categorical text data when such categories have semantic meaning, e.g., product categories in a deep-learning recommendation model.

Generally, an embedding is a low-dimensional vector of floats presentation of structured and unstructured data—e.g., text, image and video. Structured data embedding involves representing tabular data in a continuous numerical space, capturing the inherent relationships and patterns within the data, e.g., Principal Component Analysis (PCA) aims to find the linear combination of the original feature that achieves the maximum variance. Unstructured data on the other hand, focus more on transforming high-dimensional text, images, or video into a vector of floats that preserve their semantic relationships. Embeddings are very important for tasks like natural language processing, image processing, recommendation systems, etc.

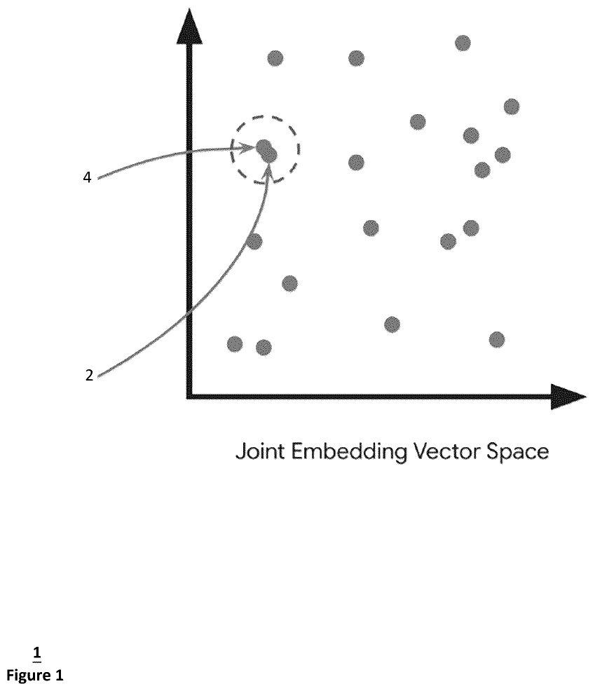

The term “modal” generally refers to data type. For example, text is one data type, image is another. Embeddings are used to map high-dimensional entities into a low-dimensional space, multimodal embedding refers to the process of representing and capturing information from multiple modalities in a common, shared space. Multimodal embedding intends to create a shared representation space where information across modalities can be compared, analyzed, and utilized jointly. For example, with reference to FIG. 1, the text “a dog in a grass field playing fetch with a ball” 2 and an image 4 corresponding to that text are represented in close proximity, e.g., as a single point ideally, in the same embedding space. Such proximity may be specified via a proximity metric.

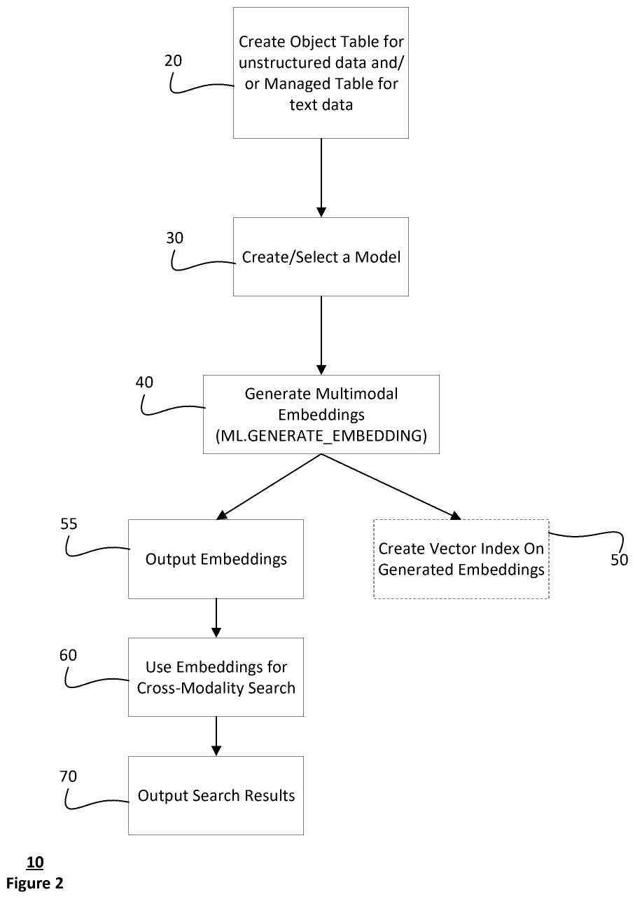

FIG. 2 illustrates the steps of a process flow 10 for an example use case in accordance with an aspect of the disclosed technology. At step 20, the process includes creating an object table associated with unstructured data. Generally, unstructured data includes data that has no set format. Examples of unstructured data include text (e.g., a text message), image, video or multimedia data. Structured data generally refers to tabular data. The unstructured data used to generate the object table in step 20 may be stored in a bucket in the cloud or a database in a distributed computing environment. For instance, it may comprise images for which a user wants to generate embeddings. In accordance with an aspect of the disclosed technology, an object table may be created as follows:

```
CREATE OR REPLACE EXTERNAL TABLE
  ‘bqml_tutorial.met_images‘
WITH CONNECTION ‘Location.ConnectionID‘
OPTIONS
( object_metadata = ′SIMPLE′,
  uris = [′gs://gcs-public-data--met/*′]
);
```

In this example, the object table contains (or points to the images at storage location) public domain art images from a museum stored in a cloud storage bucket.

The resulting object table may employ the following schema:

| column name | data type |
|---|---|
| uri | STRING |
| generation | INT64 |
| content type | STRING |
| size | INT64 |
| md5_hash | STRING |
| updated | TIMESTAMP |
| metadata | ARRAY<STRUCT<name STRING, value STRING>> |

With the object table created, processing moves to step 30 where a model is created or selected. The model may comprise a machine learning (ML) model associated with a serverless cloud data warehouse, e.g., BigQuery. In keeping with the example, a model may be created or selected as follows.

CREATE OR REPLACE MODEL
bqml_tutorial.multimodal_embedding_model REMOTE
WITH CONNECTION ‘LOCATION.CONNECTION_ID‘
OPTIONS (endpoint = ′multimodalembedding@001′)

While the multimodalembedding@001 model supports embedding generation for text, it is typically specifically designed for cross-modal semantic search scenarios, such as for example, searching images given text.

Processing now moves to step 40, where the multimodal embeddings are generated. In accordance with an aspect of the disclosed technology, the multimodal embeddings may be generated using a unified SQL syntax. Functionally, the multimodal embedding generation function is represented via a ML.GENERATE_EMBEDDING function. This function may also invoke text embeddings (e.g., via the textembedding-gecko model) and structured data embeddings (e.g., via PCA, AutoEncoder and Matrix Factorization models). These embeddings can be generated by passing the object table and embedding model created in the previous steps to the ML.GENERATE_EMBEDDING function. In accordance with step 40, the multimodal embeddings may be generated as follows:

```
CREATE OR REPLACE TABLE ‘bqml_tutorial.met_image_embeddings‘
AS
SELECT *
FROM
  ML.GENERATE_EMBEDDING(
    MODEL ‘bqml_tutorial.multimodal_embedding_model‘,
    (SELECT * FROM TABLE ‘bqml_tutorial.met_images‘ WHERE content_type =
′image/jpeg′ LIMIT 10000))
```

In accordance with this example, the generated embeddings have a dimension of 1408.

As shown in FIG. 2, the process 10 may include an optional step 50 of creating a vector index on the embeddings generated in step 40. While the embeddings generated in the previous step can be persisted and used directly in downstream models and applications, a vector index may improve embedding search performance and enabling the nearest-neighbor query pattern. A vector index may be created as follows.

-- Create a vector index on the embeddings
CREATE OR REPLACE VECTOR INDEX ‘met_images_index‘
ON bqml_tutorial.met_image_embeddings(ml_generate_embedding_result)
OPTIONS(index_type = ′IVF′,
distance_type = ′COSINE′)

The embeddings that are generated at step 40, are output at step 55. At step 60 of process 10, the embeddings generated are used for cross-modality (text-to-image) searches. For instance, continuing with the example, the images for which embeddings have been generated may be searched using a text string. To search the images from the museum for “pictures of white or cream colored dress from victorian era” a search string is first embedded as follows.

```
-- embed search string
CREATE OR REPLACE TABLE ‘bqml_tutorial.search_embedding‘
AS
SELECT * FROM ML.GENERATE_EMBEDDING(
  MODEL ‘bqml_tutorial.multimodal_embedding_model‘,
  (
    SELECT ″pictures of white or cream colored dress from victorian era″ AS content
  )
)
```

The following embedded search string may be used to find similar (e.g., nearest) image embeddings as follows.

```
-- use the embedded search string to search for images
CREATE OR REPLACE TABLE
  ‘bqml_tutorial.vector_search_results‘ AS
SELECT
  base.uri AS gcs_uri,
  distance
FROM
  VECTOR_SEARCH( TABLE ‘bqml_tutorial.met_image_embeddings‘,
    ″ml_generate_embedding_result″,
    TABLE ‘bqml_tutorial.search_embedding‘,
    ″ml_generate_embedding_result″,
    top_k => 5)
```

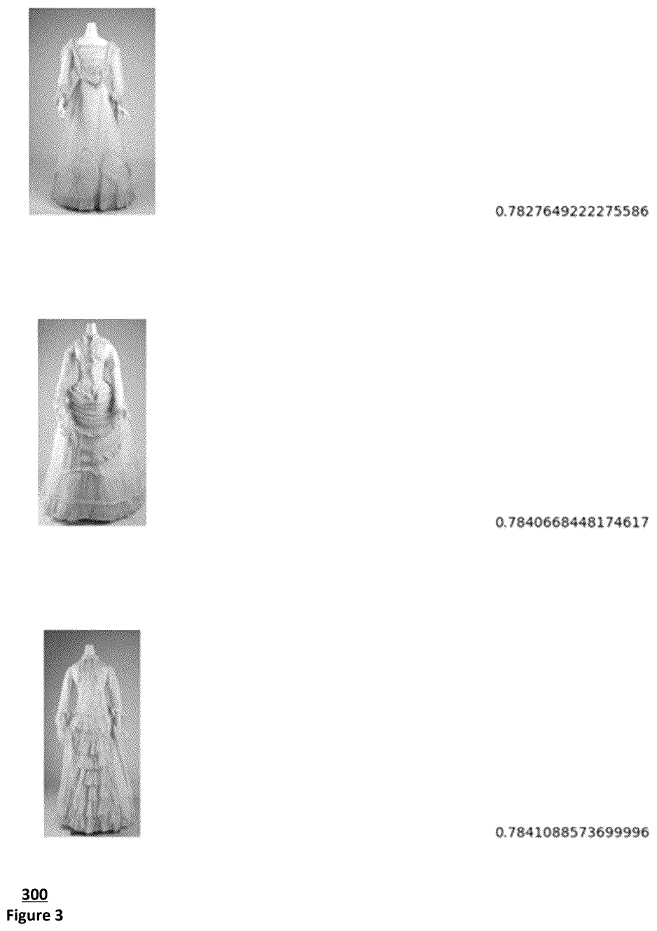

At step 70, the results are outputted. For this example use case, the Victorian dresses shown in FIG. 3 resulted from the query in step 60.

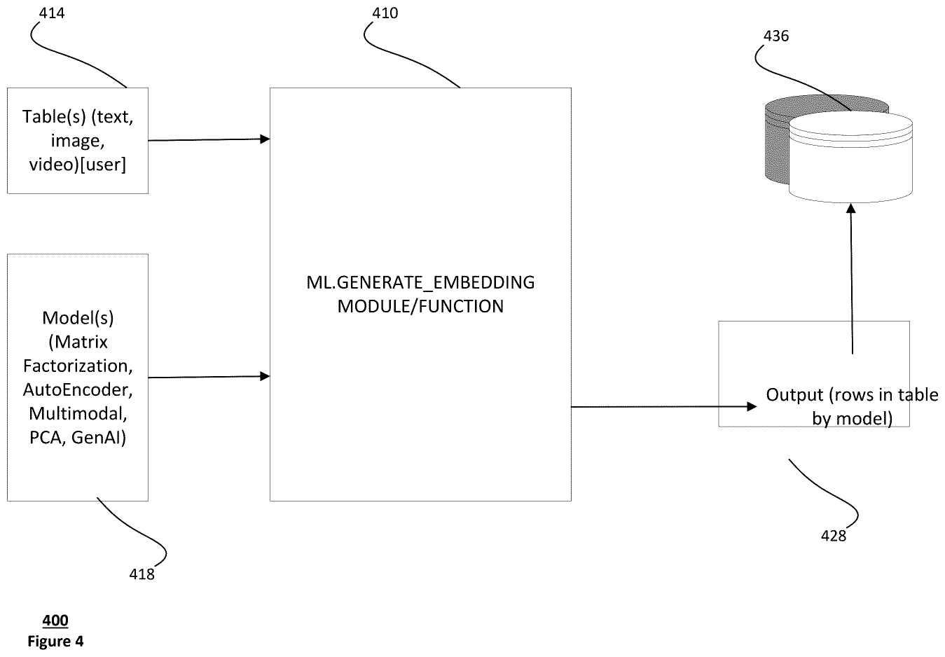

FIG. 4 illustrates a high level functional architecture 400 for a serverless cloud computing system in accordance with an aspect of the disclosed technology. The architecture includes ML.Generate_Embedding module or engine 410 that receives as input one or more tables 414 and one or more models 418. The ML.Generate_Embedding module 410 generates an output 428, which includes rows in a table based on the models. Output 428 is used to populate serverless cloud data warehouse 436.

Table 414 may comprise read-only object tables over unstructured objects that reside in a cloud storage bucket. An object table, for example, can include a fixed column that is used to identify the location of the image or video, or other multimedia data, in cloud storage. It also includes a fixed column that is used to identify the type of content, e.g., image—JPEG, video—MP4. The object table may support mixed content type inputs, e.g., one object table may contain image type (image/jpeg) and video type (video/mp4). The object table must include a column “uri” and the “content_type” column. Table 414 may also comprise a managed table for text that includes a column for content. In a case where the input consists of multimedia input and text (e.g., a presentation with image/video and text), the image and video are inputted via an object table, while the text is inputted via a managed table.

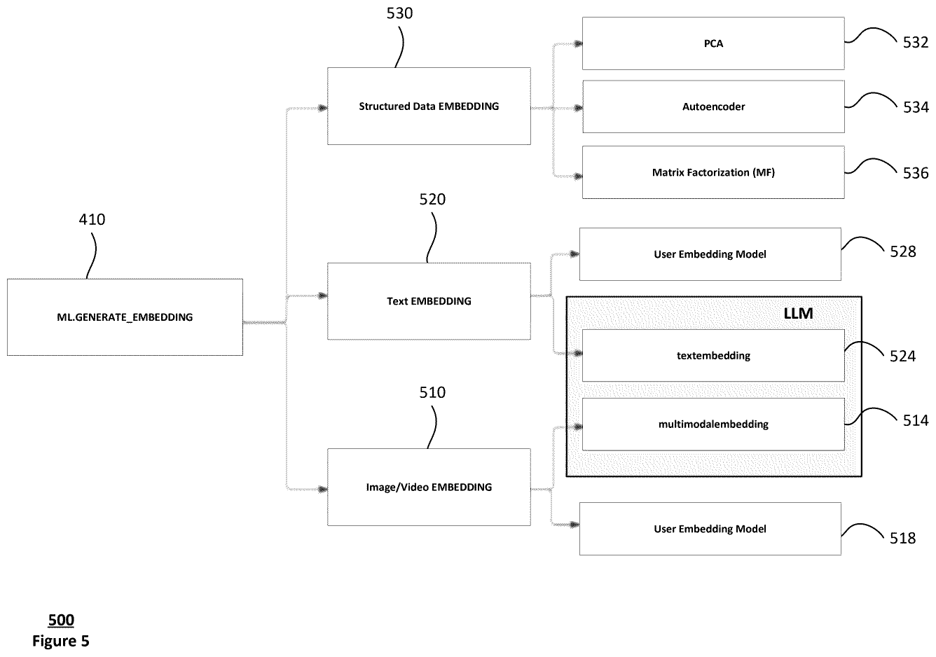

The models 418 may include PCA, AutoEncoder, Matrix Factorization, MultiModalEmbedding, TextEmbedding, Generative AI and User Embedding models. FIG. 5 illustrates the processing flow 500 for the ML.Generate_Embedding function or engine 410. As shown, where the function is used to generate multimodal embeddings, image/video embedding sub-module 510 operates to use either multimodalembedding model 514 or user embedding model 518 to process the image/video input via the object table. Where text is inputted to the function via a managed table, text embedding module 520 operates to use either textembedding model 524 or user embedding model 528, which may be the same as user embedding model 518. Where structured data is inputted, structured data embedding submodule 530 operates using one or more of PCA 532, Autoencoder 534 or Matrix factorization 536 to process the structured data.

The output 428 uses a unified embedding scheme for all the modalities processed. Specifically, text and images share the same output schema, while video includes additional data. For example, text and image embeddings may comprise two columns in a table-one column that includes the values of the vector array and another column which includes the string type. For video, additional columns may be needed to reflect start and end time of the video.

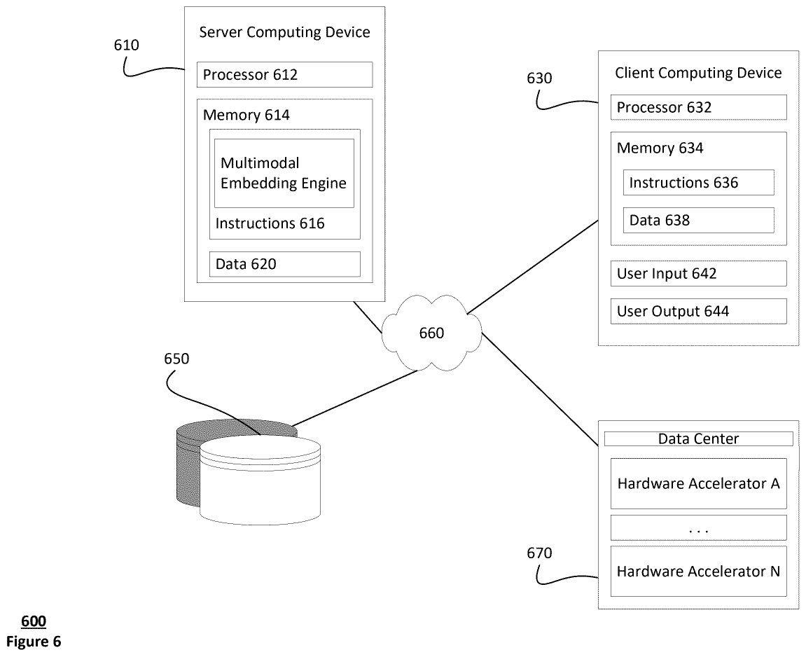

FIG. 6 depicts a block diagram of an example environment for implementing a multimodal embedding generation system 600. The system 600 can be implemented on one or more devices having one or more processors in one or more locations, such as in server computing device 610. Client computing device 630 and the server computing device 610 can be communicatively coupled to one or more serverless cloud data warehouses or storage devices 650 over a network 660. The serverless cloud data warehouse or storage devices 650 can be a combination of volatile and non-volatile memory and can be at the same or different physical locations than the computing devices. For example, the serverless cloud data warehouses or storage devices 650 can include any type of non-transitory computer-readable medium capable of storing information, such as a hard drive, solid state drive, tape drive, optical storage, memory card, ROM, RAM, DVD, CD-ROM, write-capable, and read-only memories.

The server computing device 610 can include one or more processors 612 and memory 614. The memory 614 can store information accessible by the processors 612, including instructions 616 that can be executed by the processors. The memory 614 can also include data 620 that can be retrieved, manipulated, or stored by the processors. The memory 614 can be a type of non-transitory computer-readable medium capable of storing information accessible by the processors, such as volatile and non-volatile memory. The processors 612 can include one or more central processing units (CPUs), graphic processing units (GPUs), field-programmable gate arrays (FPGAs), and/or application-specific integrated circuits (ASICs), such as tensor processing units (TPUs).

The instructions 616 can include one or more instructions that, when executed by the processors 612, cause the one or more processors to perform actions defined by the instructions. The instructions can be stored in object code format for direct processing by the processors, or in other formats including interpretable scripts or collections of independent source code modules that are interpreted on demand or compiled in advance. The instructions 616 can include instructions for implementing a multimodal embedding generation function, which can correspond to the processing flows, architecture or system of FIGS. 2, 4 and 5. The instructions 616 can be executed using the processors 612, and/or using other processors remotely located from the server computing device 610.

The data 620 can be retrieved, stored, or modified by the processors 612 in accordance with the instructions 616. The data 620 can be stored in computer registers, in a relational or non-relational database as a table having a plurality of different fields and records, or as JSON, YAML, proto, or XML documents. The data can also be formatted in a computer-readable format such as, but not limited to, binary values, ASCII, or Unicode. Moreover, the data can include information sufficient to identify relevant information, such as numbers, descriptive text, proprietary codes, pointers, references to data stored in other memories, including other network locations, or information that is used by a function to calculate relevant data.

The client computing device 630 can also be configured similarly to the server computing device, with one or more processors 632, memory 634, instructions 636, and data 638. The client computing device can also include a user input 642 and a user output 644. The user input can include any appropriate mechanism or technique for receiving input from a user, such as keyboard, mouse, mechanical actuators, soft actuators, touchscreens, microphones, and sensors.

The server computing device 610 can be configured to transmit data to the client computing device 630, and the client computing device 630 can be configured to display at least a portion of the received data on a display implemented as part of the user output 644. The user output 644 can also be used for displaying an interface between the client computing device 630 and the server computing device 610. The user output 644 can alternatively or additionally include one or more speakers, transducers or other audio outputs, a haptic interface, or other tactile feedback that provides non-visual and non-audible information to the platform user of the client computing device.

Although FIG. 6 illustrates the processors and the memories as being within the computing devices, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

The server computing device 610 can be connected over the network 660 to a data center 670 housing any number of hardware accelerators. The data center 670 can be one of multiple data centers or other facilities in which various types of computing devices, such as hardware accelerators, are located. Computing resources housed in the data center can be specified for deploying models related to structured data embedding, text embedding, user embedding and multimodal embedding as described herein.

The server computing device 610 can be configured to receive requests to process data from the client computing device 630 using computing resources in the data center 670 and for outputting to serverless cloud data warehouse 650. For example, the environment can be part of a cloud computing platform configured to provide a variety of services to users, through various user interfaces and/or application programming interfaces (APIs) exposing the platform services. The variety of services can include generating multimodal embeddings for a serverless cloud data warehouse 650 and searching a serverless cloud data warehouse 650 configured with such multimodal embeddings. The client computing device 630 can transmit input data associated with object tables or managed tables or search strings or queries. The server computing device 610 can receive the input data, and in response, generate output data including a multimodal embeddings for serverless cloud data warehouse 650 or search results to return to the client computing device 630 based on multimodal embeddings associated with serverless cloud data warehouse 650.

As discussed above, the ML.GENERATE_EMBEDDING function receives as input one or more machine learning models, e.g., Matrix Factorization, AutoEncoder, Multimodalembedding, PCA, GenAI. The disclosed technology is not limited to these models and other models may be used. Such models may be developed using inference data and training data. The inference data can be data associated with text, audio, image or video. The training data can correspond to an AI or machine learning task for creating multimodal embeddings, such as a task performed by a neural network. The training data can be split into a training set, a validation set, and/or a testing set. An example training/validation/testing split can be an 80/10/10 split, although any other split may be possible. The training data can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

Examples of machine learning tasks follow. As an example, the input to the machine learning model can be in the form of images or videos. A machine learning model can be trained to extract, identify, and generate features as part of processing a given input, for example as part of a computer vision task. A machine learning model trained to perform this type of machine learning model task can be trained to generate an output classification from a set of different potential classifications. In addition or alternatively, the neural network can be trained to output a score corresponding to an estimated probability that an identified subject in the image or video belongs to a certain class.

As another example, the input to the machine learning model can be data files corresponding to a particular format, e.g., HTML files, word processing documents, or formatted metadata obtained from other types of data, such as metadata for image files. A machine learning model task in this context can be to classify, score, or otherwise predict some characteristic about the received input. For example, a machine learning model can be trained to predict the probability that received input includes text relating to a particular subject. Also as part of performing a particular task, the machine learning model can be trained to generate text predictions, for example as part of a tool for auto-completion of text in a document as the document is being composed. A machine learning model can also be trained for predicting a translation of text in an input document to a target language, for example as a message is being composed.

Other types of input documents can be data relating to characteristics of a network of interconnected devices. These input documents can include activity logs, as well as records concerning access privileges for different computing devices to access different sources of potentially sensitive data. A machine learning model can be trained for processing these and other types of documents for predicting on-going and future security breaches to the network. For example, the machine learning model can be trained to predict intrusion into the network by a malicious actor.

As another example, the input to a machine learning model can be audio input, including streamed audio, pre-recorded audio, and audio as part of a video or other source or media. A machine learning model task in the audio context can include speech recognition, including isolating speech from other identified sources of audio and/or enhancing characteristics of identified speech to be easier to hear. A machine learning model can be trained to predict an accurate translation of input speech to a target language, for example in real-time as part of a translation tool.

In addition to data input, including the various types of data described herein, a neural network can also be trained to process features corresponding to given input. Features are values, e.g., numerical or categorical, which relate to some characteristic of the input. For example, in the context of an image, a feature of the image can relate to the RGB value for each pixel in the image. A machine learning model task in the image/video context can be to classify contents of an image or video, for example for the presence of different people, places, or things. A machine learning model can be trained to extract and select relevant features for processing to generate an output for a given input, and can also be trained to generate new features based on learned relationships between various characteristics of input data.

Although the technology herein has been described with reference to particular examples, it is to be understood that these examples are merely illustrative of the principles and applications of the disclosed technology. It is, therefore, to be understood that numerous modifications may be made to the illustrative examples and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only some but not all possible variations of the disclosed technology. Further, the same reference numbers in different drawings can identify the same or similar elements.

1. A process for generating embeddings, comprising:
receiving multimodal data, the multimodal data including input text and one or more of input image data and input video data;
selecting one or more machine learning models; and
applying the one or more machine learning models to the multimodal data to generate data embeddings for a semantic space, wherein the data embeddings configure the semantic space to include relationships between the input text and the one or more of input image data and input video data.

2. The process of claim 1, wherein the relationships are represented by vectors associated with the input text data and the one or more of input image data and input video data.

3. The process of claim 2, wherein a proximity metric associated with the vectors define the relationships between the input text data and the one or more of input image data and input video data.

4. The process of claim 2, comprising storing the data embeddings in a serverless cloud data warehouse.

5. The process of claim 1, wherein the data embeddings comprise text embeddings and image embeddings having a same dimensionality.

6. The process of claim 5, wherein the same dimensionality comprises having vectors associated with the data embeddings be equal in size to vectors associated with image embeddings.

7. The process of claim 1, comprising querying the serverless cloud data warehouse using a text query and receiving as output response image data or response video data.

8. The process of claim 1, wherein applying comprises using a unified SQL syntax to generate the data embeddings.

9. The process of claim 1, comprising training one or more downstream machine learning models using the data embeddings.

10. The process of claim 1, wherein the data embeddings comprise structured data embeddings and the one or more machine learning models include one or more of a Principal Component Analysis (PCA) model, an AutoEncoder and Matrix Factorization.

11. The process of claim 1, comprising generating a vector index using the data embeddings.

12. A system, comprising:
one or more processing devices;
a memory containing instructions, the instructions when executed by the one or more processing devices cause the one or more processing devices to:
receive multimodal data, the multimodal data including input text and one or more of input image data and input video data;
select one or more machine learning models; and
apply the one or more machine learning models to the multimodal data to generate data embeddings for a semantic space, wherein the data embeddings configure the semantic space to include relationships between the input text and the one or more of input image data and input video data.

13. The system of claim 12, wherein the instructions when executed by the one or more processing devices cause the one or more processing devices to output the data embeddings to a serverless cloud data warehouse.

14. The system of claim 13, wherein the instructions when executed by the one or more processing devices cause the one or more processing devices to query the serverless cloud data warehouse using a text query and receive as output response image data or response video data.

15. The system of claim 12, wherein the data embeddings comprise text embeddings and image embeddings having a same dimensionality.

16. The system of claim 15, wherein the same dimensionality comprises having vectors associated with data embeddings be equal in size to vectors associated with image embeddings.

17. The system of claim 12, wherein the one or more machine learning models includes a multimodal machine learning model.

18. One or more non-transitory computer program products storing instructions that, when executed by at least one programmable processor, cause the at least one programmable processor to perform operations comprising:
receiving multimodal data, the multimodal data including input text and one or more of input image data and input video data;
selecting one or more machine learning models; and
applying the one or more machine learning models to the multimodal data to generate data embeddings for a semantic space, wherein the data embeddings configure the semantic space to include relationships between the input text and the one or more of input image data and input video data.

19. The one or more non-transitory computer program products of claim 18, wherein the data embeddings comprise text embeddings and image embeddings having a same dimensionality and wherein the same dimensionality comprises having vectors associated with the data embeddings be equal in size to vectors associated with image embeddings.

20. The one or more non-transitory computer program products of claim 18, wherein the instructions when executed by the least one programmable processor, cause the at least one programmable processor to perform operations comprising querying a serverless cloud data warehouse using a text query and receive as output response image data or response video data.
